(19) United States
(12) Patent Application Publication
(10) Pub. No.: US 2016/0140513 A1
(43) Pub. Date: May 19, 2016

(54) TERMINAL APPARATUS, FAULT REPORT SYSTEM, AND NON-TRANSITORY COMPUTER READABLE MEDIUM

(71) Applicant: FUJI XEROX CO., LTD., Tokyo (JP)

(72) Inventor: Hayato YOSHIKAWA, Yokohama-shi (JP)

(21) Appl. No.: 14/721,662

(22) Filed: May 26, 2015

(30) Foreign Application Priority Data
Nov. 17, 2014 (JP) 2014-233072

(51) Int. Cl. G06Q 10/00

(52) U.S. Cl. CPC G06Q 10/20

(57) ABSTRACT

A terminal apparatus includes a display and an input unit. The display displays at least an input screen for displaying plural entries to be input and a browsing screen for browsing the plural entries which have already been input. The input unit inputs the plural entries. The display displays the plural entries at different positions on the display between the input screen and the browsing screen.

### CROSS-REFERENCE TO RELATED APPLICATIONS

This application is based on and claims priority under 35 USC 119 from Japanese Patent Application No. 2014-233072 filed Nov. 17, 2014.

### BACKGROUND

### Technical Field

The present invention relates to a terminal apparatus, a fault report system, and a non-transitory computer readable medium.

### SUMMARY

According to an aspect of the invention, there is provided a terminal apparatus including a display and an input unit. The display displays at least an input screen for displaying plural entries to be input and a browsing screen for browsing the plural entries which have already been input. The input unit inputs the plural entries. The display displays the plural entries at different positions on the display between the input screen and the browsing screen.

### BRIEF DESCRIPTION OF THE DRAWINGS

Exemplary embodiments of the present invention will be described in detail based on the following figures, wherein:

FIG. 1 is a diagram illustrating a fault report system according to an exemplary embodiment of the present invention;

FIG. 2 is a diagram illustrating an image forming apparatus, which is an example of a maintenance target for which a fault is reported in the fault report system illustrated in FIG. 1;

FIG. 3 is a diagram illustrating a terminal apparatus included in the fault report system illustrated in FIG. 1;

FIG. 4 is a diagram illustrating a state in which the terminal apparatus illustrated in FIG. 3 displays an initial screen;

FIG. 5 is a first diagram illustrating a state in which the terminal apparatus illustrated in FIG. 3 displays an input screen;

FIG. 6 is a second diagram illustrating a state in which the terminal apparatus illustrated in FIG. 3 displays an input screen on which a lower part than the part displayed on the input screen in FIG. 5 is displayed;

FIG. 7 is a third diagram illustrating a state in which the terminal apparatus illustrated in FIG. 3 displays an input screen on which a lower part than the part displayed on the input screen in FIG. 6 is displayed;

FIG. 8 is a fourth diagram illustrating a state in which the terminal apparatus illustrated in FIG. 3 displays an input screen on which a lower part than the part displayed on the input screen in FIG. 7 is displayed;

FIG. 9 is an enlarged illustration of a schematic diagram displayed on a display device of the terminal apparatus illustrated in FIG. 3;

FIG. 10 is a first diagram illustrating a state in which the terminal apparatus illustrated in FIG. 3 displays a browsing screen;

FIG. 11 is a second diagram illustrating a state in which the terminal apparatus illustrated in FIG. 3 displays a browsing screen on which a lower part than the part displayed on the browsing screen in FIG. 10 is displayed;

FIG. 12 is a third diagram illustrating a state in which the terminal apparatus illustrated in FIG. 3 displays a browsing screen on which a lower part than the part displayed on the browsing screen in FIG. 11 is displayed;

FIG. 13 is a fourth diagram illustrating a state in which the terminal apparatus illustrated in FIG. 3 displays a browsing screen on which a lower part than the part displayed on the browsing screen in FIG. 12 is displayed; and

FIG. 14 is a flowchart explaining a process performed by the terminal apparatus illustrated in FIG. 3.

### DETAILED DESCRIPTION

Exemplary embodiments of the present invention will be described below with reference to figures.

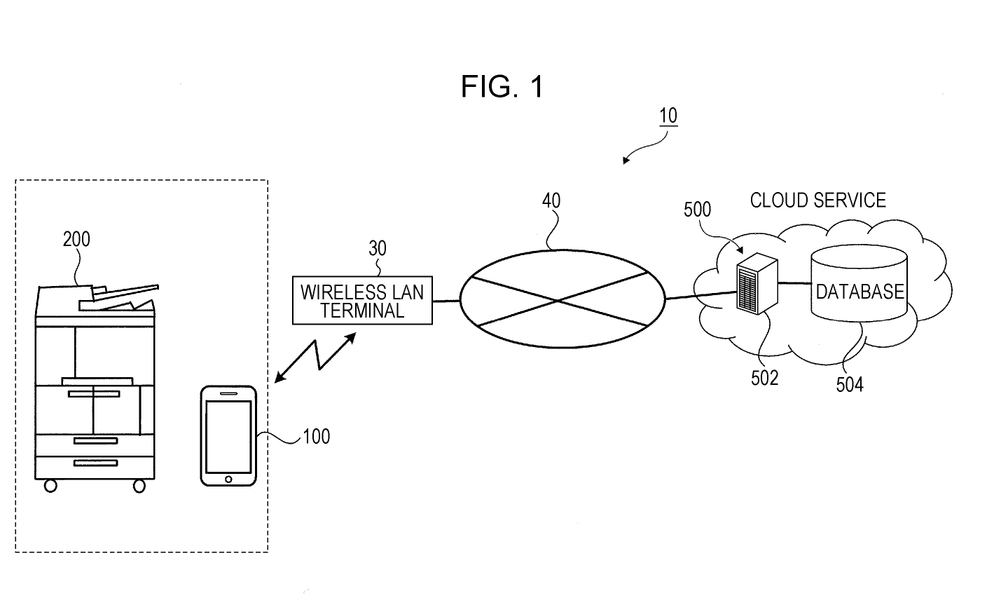

FIG. 1 illustrates a fault report system 10 according to an exemplary embodiment of the present invention. As illustrated in FIG. 1, the fault report system 10 includes a terminal apparatus 100 such as a personal computer, a smartphone, or a tablet terminal apparatus, a server apparatus 502, and a database 504 that is used as a memory. The server apparatus 502 and the database 504 form a parent apparatus 500 which performs communication with the terminal apparatus 100.

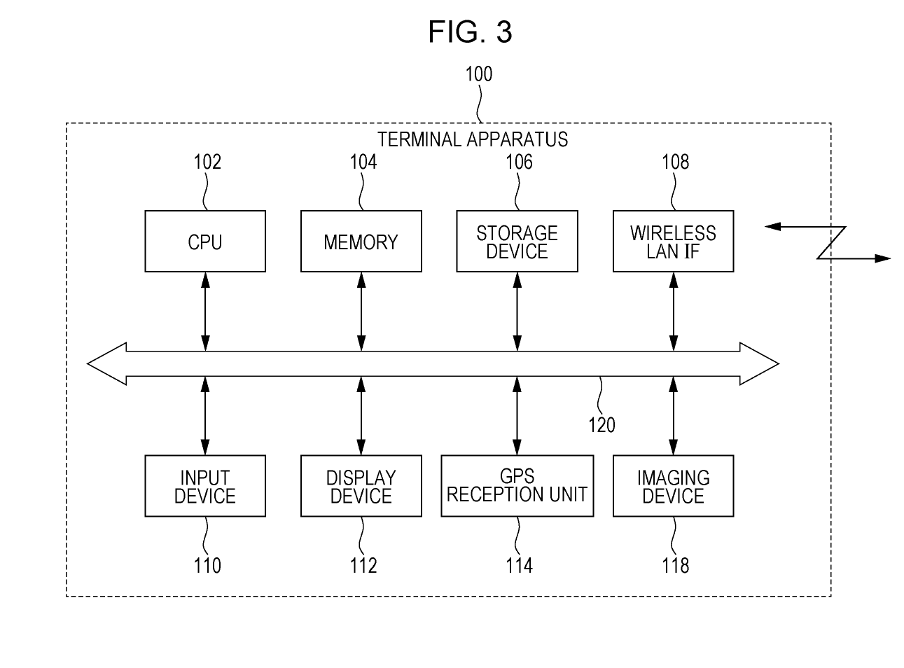

In the present invention, the terminal apparatus 100 may be of any type as long as it is capable of communicating with the server apparatus 502 through a communication network and reporting fault information to the server apparatus 502. In this exemplary embodiment, a case will be described where the terminal apparatus 100 is a smartphone which includes an imaging device 118 (see FIG. 3) capable of photographing a fault occurrence location and a touch panel used as an input device 110 (see FIG. 3) and capable of touch input.

The terminal apparatus 100 is carried by a serviceman (maintenance worker) who performs maintenance management, repair, and the like of an image forming apparatus 200, such as a printer, used by an end user. The terminal apparatus 100 is used to input and transmit fault information to the server apparatus 502 and to browse through the server apparatus 502 fault information stored in the database 504.

The terminal apparatus 100 and the server apparatus 502 are connected through a wireless local area network (LAN) terminal 30 such as a Wi-Fi router and an Internet communication network 40, and perform transmission and reception of fault information and the like.

In the case where the terminal apparatus 100 is a cellular phone apparatus, a smartphone, or the like, the terminal apparatus 100 and the server apparatus 502 may be connected through a cellular phone line network to enable transmission and reception of fault information.

In the fault report system 10 according to this exemplary embodiment, when a fault such as a breakdown or abnormal behavior has occurred in the image forming apparatus 200, which is a maintenance target installed in the place of an end user, a serviceman who is carrying the terminal apparatus 100 comes to the place of the image forming apparatus 200. Then, the serviceman inputs fault information including a model name of the product, a serial number, fault content, and a picture of the fault occurrence location to the terminal apparatus 100, and transmits the fault information to the server apparatus 502 through the wireless LAN terminal 30 and the Internet communication network 40.

The server apparatus 502 stores and saves the received fault information in the database 504. In response to a browsing request from the terminal apparatus 100, the server apparatus 502 searches the database 504 and forwards corresponding fault information to the terminal apparatus 100.

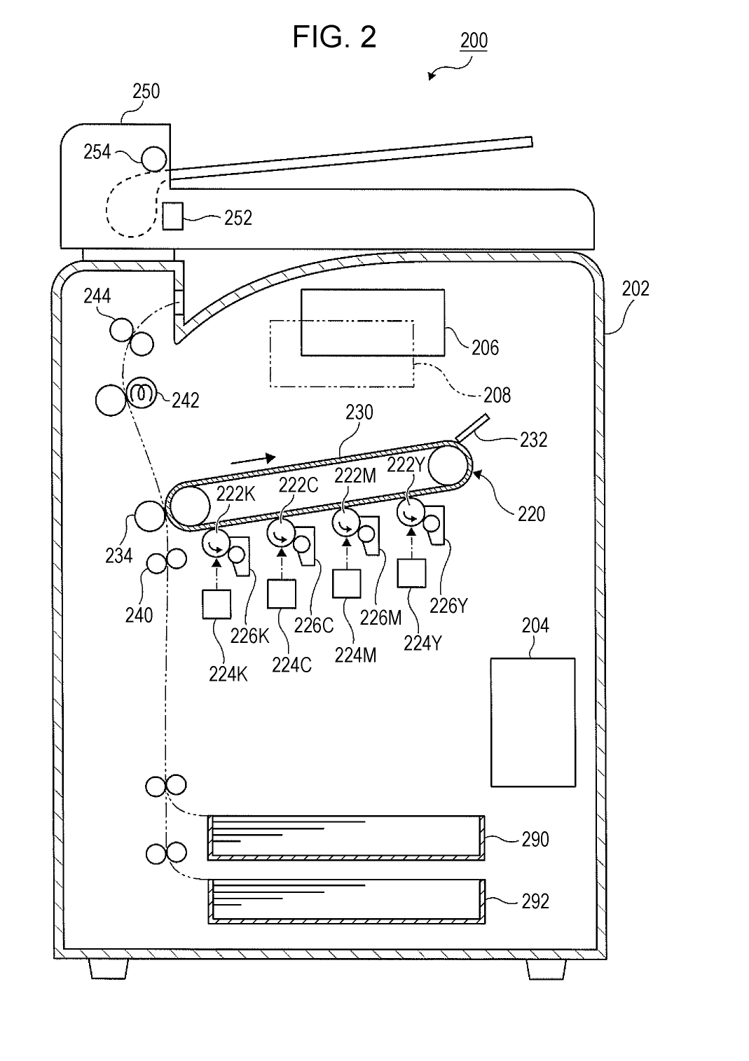

FIG. 2 illustrates the image forming apparatus 200. As illustrated in FIG. 2, the image forming apparatus 200 includes an image forming apparatus body 202. Inside the image forming apparatus body 202, a power supply unit 204 and a controller 206 are arranged. Furthermore, for example, on a side plate on a front side of the image forming apparatus body 202, a display device 208 is mounted. The display device 208 displays, for example, information regarding the image forming apparatus 200, such as a location where a fault is occurring in the image forming apparatus 200.

Furthermore, inside the image forming apparatus body 202, a toner image forming unit 220 that forms a toner image, a first paper feeding device 290 that feeds paper to the toner image forming unit 220, and a second paper feeding device 292 that feeds paper to the toner image forming unit 220, are arranged.

The toner image forming unit 220 includes photoconductor drums 222Y, 222M, 222C, and 222K, and exposure devices 224Y, 224M, 224C, and 224K that expose the corresponding photoconductor drums to light to form latent images on the corresponding photoconductor drums. The toner image forming unit 220 also includes a developing device 226Y that develops with yellow toner the latent image formed on the photoconductor drum 222Y, a developing device 226M that develops with magenta toner the latent image formed on the photoconductor drum 222M, a developing device 226C that develops with cyan toner the latent image formed on the photoconductor drum 222C, and a developing device 226K that develops with black toner the latent image formed on the photoconductor drum 222K.

The toner image forming unit 220 further includes a transfer belt 230 onto which a toner image is transferred from each of the photoconductor drums 222Y, 222M, 222C, and 222K, a cleaning device 232 that cleans the transfer belt 230, and a secondary transfer device 234 that further transfers the toner image from the transfer belt 230 to paper.

Inside the image forming apparatus body 202, a resist roller 240 that is used for controlling a timing at which paper is conveyed to a position where the toner image is transferred from the transfer belt 230 to the paper, a fixing device 242 that fixes on the paper the toner image which has been transferred to the paper, and a discharge roller 244 that discharges, out of the image forming apparatus body 202, the paper on which the toner image has been fixed, are arranged.

The image forming apparatus 200 further includes a document reading device 250 that includes a document reading unit 252 that reads a document and a document feeding unit 254 that feeds a document to the document reading unit 252.

A fault, such as a breakdown or reaching the time for replacement, may occur in each portion of the image forming apparatus 200 described above. When a fault occurs in a portion of the image forming apparatus 200, the location where the fault has occurred and the content of the fault may be displayed on the display device 208 using a predetermined code, for example.

FIG. 3 illustrates the terminal apparatus 100. The terminal apparatus 100 includes, as illustrated in FIG. 3, a central processing unit (CPU) 102, a memory 104 which is capable of temporarily storing data, a storage device 106 such as a flash memory, a wireless LAN interface (IF) 108 which performs transmission and reception of data through wireless communication with the wireless LAN terminal 30, the input device 110 such as a touch sensor, a display device 112, a global positioning system (GPS) reception unit 114, and the imaging device 118 such as a camera. These components are mutually connected through a control bus 120.

The GPS reception unit 114 detects the current location of the terminal apparatus 100. The GPS reception unit 114 receives and processes, for example, radio waves from three or more GPS satellites orbiting above the earth, and thus detects the current location of the terminal apparatus 100, for example, as location information including latitude and longitude information.

The CPU 102 executes predetermined processing based on a program stored in the memory 104 or the storage device 106 and controls operations of the terminal apparatus 100. The program may be acquired by downloading through the Internet communication network 40 or a cellular phone line network and provided to the CPU 102.

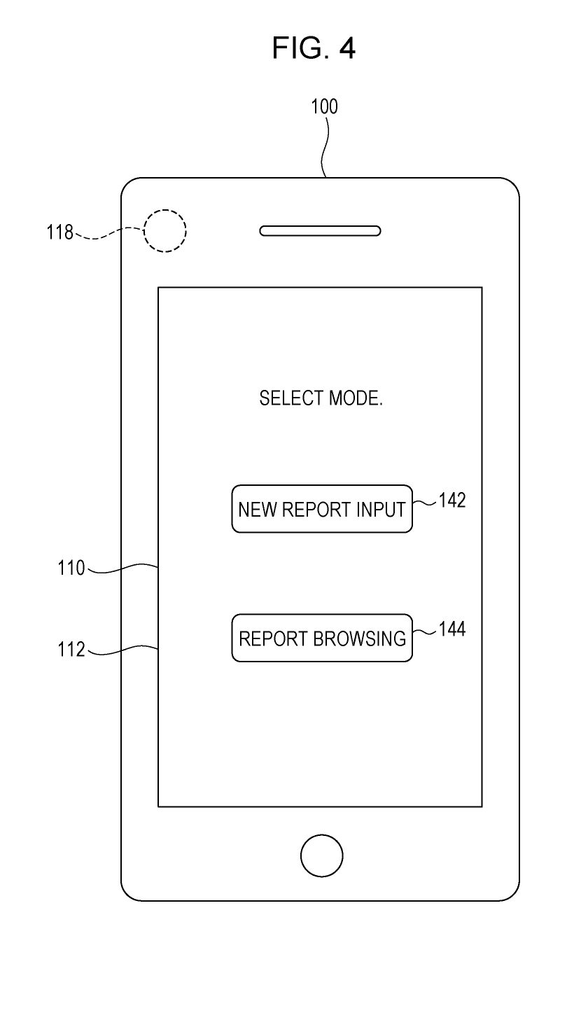

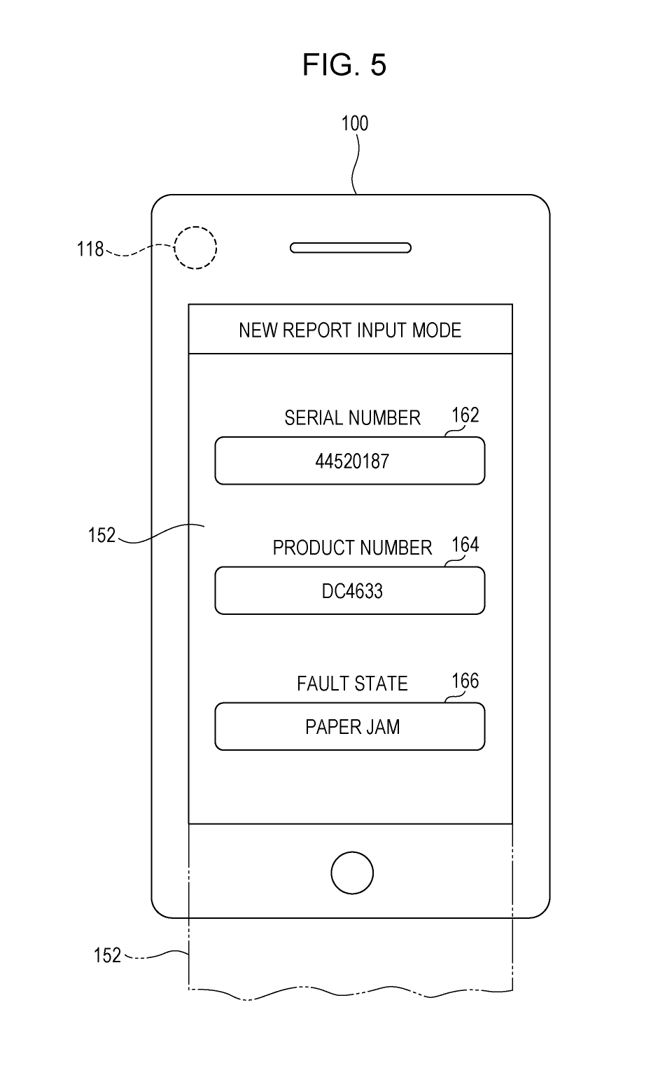

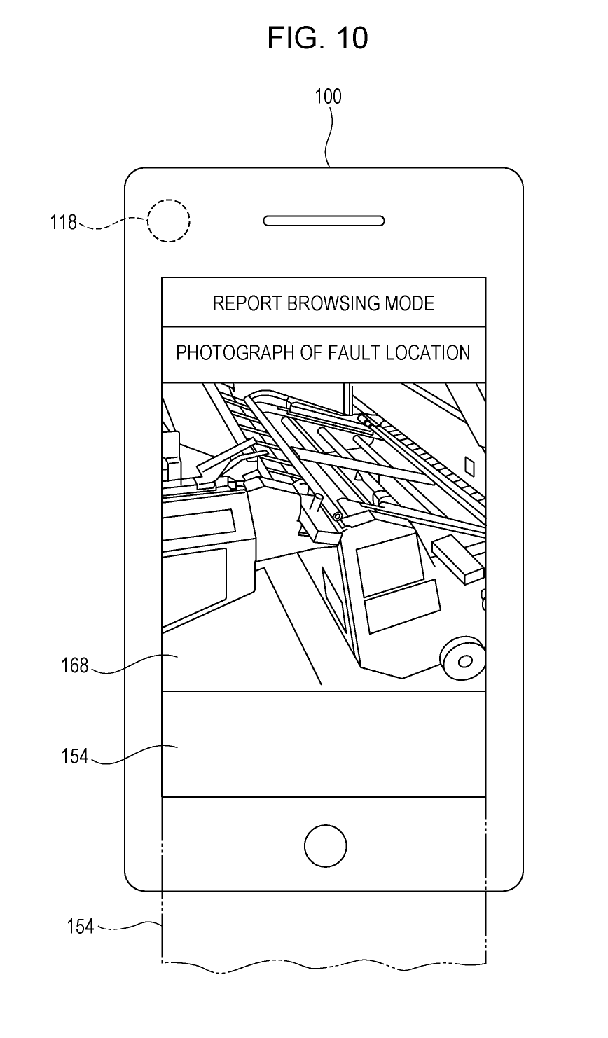

For example, a touch panel may be used as the display device 112, as described above. Furthermore, the display device 112 is used as a display that displays at least an input screen 152 (see, for example, FIG. 5) that displays plural entries to be input, and a browsing screen 154 (see, for example, FIG. 10) for browsing plural entries that have already been input. The display device 112 also displays, for example, an initial screen 140 (see FIG. 4), in addition to the input screen 152 and the browsing screen 154.

FIG. 4 illustrates the terminal apparatus 100 in a state in which the initial screen 140 is displayed. The initial screen 140 is a screen which allows reporting of a fault of the image forming apparatus 200, and is displayed on the display device 112 when a program which allows browsing of information recorded in the database 504 is started. In this exemplary embodiment, the touch panel is used as the display device 112 as well as the input device 110. In the terminal apparatus 100 illustrated in FIG. 4, the imaging device 118 is mounted on the face of the terminal apparatus 100 that is opposite the face on which the touch panel is mounted.

On the initial screen 140, a new report input button 142 and a report browsing button 144 are displayed. The new report input button 142 is a button for shifting to a new report input mode that allows transmission of new fault information to the server apparatus 502. When an operator touches the new report input button 142, the touch panel screen shifts from the initial screen 140 to the input screen 152 (see FIG. 5). The report browsing button 144 is a button for shifting to a report browsing mode that allows browsing of fault information stored in advance in the database 504. When the operator touches the report browsing button 144, the touch panel screen shifts from the initial screen 140 to the browsing screen 154 (see FIG. 10).

FIGS. 5 to 8 each illustrate the terminal apparatus 100 which displays the input screen 152, which is a screen displayed in the new report input mode. The input screen 152 is of a size that is not able to be displayed entirely on the display device 112. The entire screen may be viewed when an operator scrolls the displayed part by dragging a finger on the display device 112. FIG. 5 illustrates the first state after the screen shifts to the input screen 152.

The first state is a state in which the screen is scrolled to the uppermost part, and an entry with the highest priority for a user is displayed at the top. That is, in this case, the upper part represents a priority position, and as the screen is scrolled downwards, the priority becomes lower. A priority position represents a position of the screen in the first state displayed after shifting, and may be scrolled up and down. When the uppermost part is displayed first, the uppermost part is defined as the priority position.

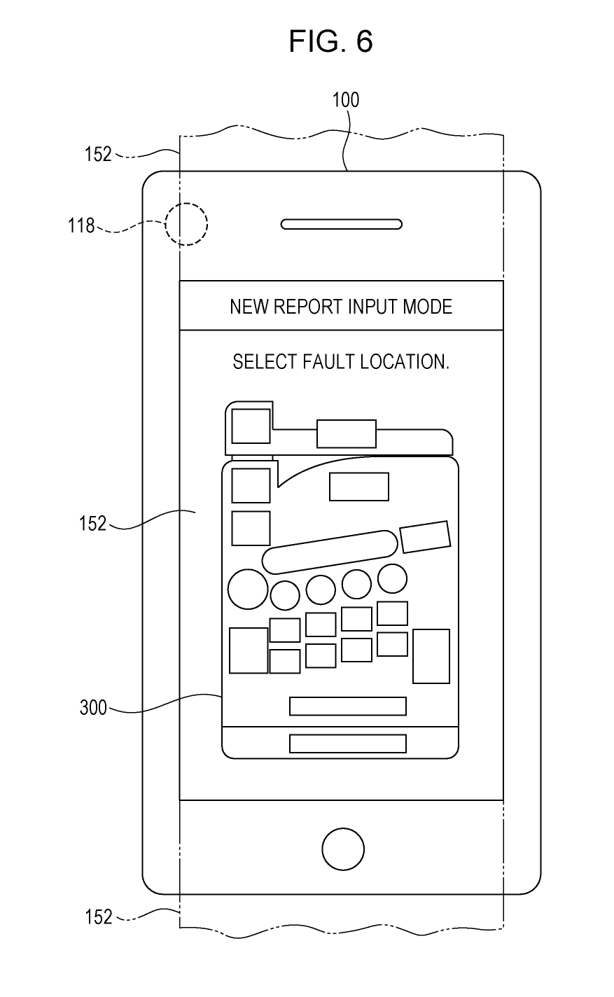

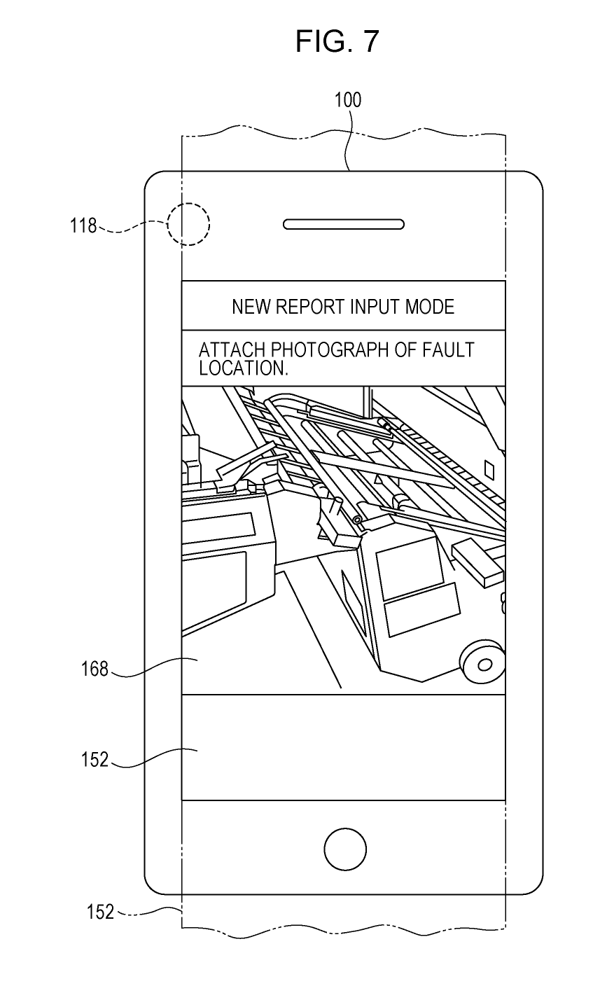

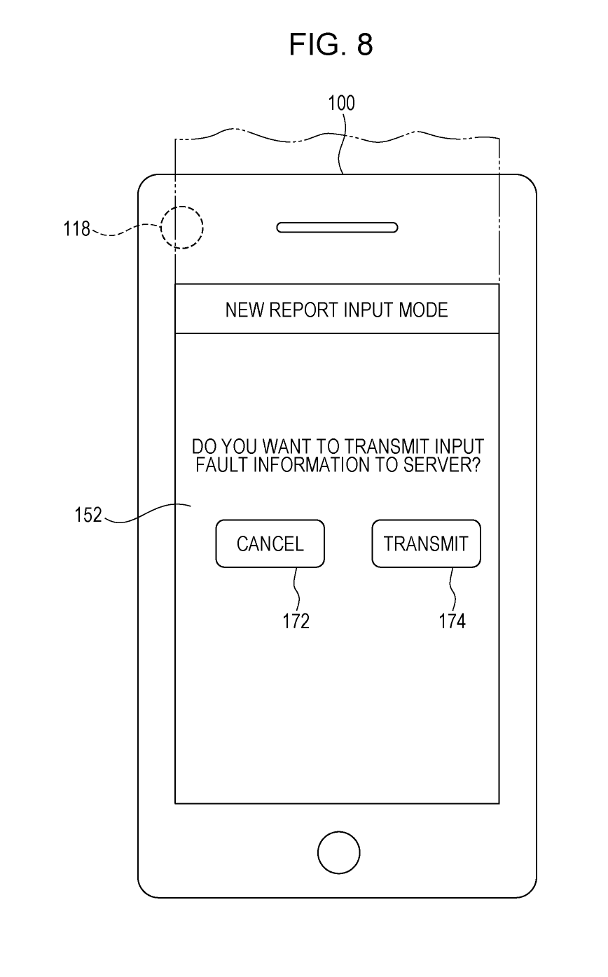

FIG. 6 illustrates the terminal apparatus 100 which displays a lower part than the part of the input screen 152 illustrated in FIG. 5. FIG. 7 illustrates the terminal apparatus 100 which displays a lower part than the part of the input screen 152 illustrated in FIG. 6. FIG. 8 illustrates the terminal apparatus 100 which displays a lower part than the part of the input screen 152 illustrated in FIG. 7.

As illustrated in FIG. 5, at the uppermost part of the input screen 152, a serial number field 162 is displayed. The serial number field 162 is a field for an operator to input a serial number, which is maintenance target identification information for identifying the image forming apparatus 200 as the maintenance target, and for displaying the serial number that is input beforehand. FIG. 5 illustrates a state in which “44520187”, which is the serial number of the image forming apparatus 200, has already been input to the serial number field 162.

Below the serial number field 162 of the input screen 152, a product number field 164 is displayed. The product number field 164 is a field for an operator to input a model number for identifying the product (model) of the image forming apparatus 200 as the maintenance target and for displaying the model number that is input beforehand. FIG. 5 illustrates a state in which “DC4633”, which is the model number of the image forming apparatus 200, is already input to the product number field 164.

Below the product number field 164 of the input screen 152, a fault state field 166 is displayed. The fault state field 166 is a field for an operator to input an explanation for a fault which is occurring in the image forming apparatus 200 and for browsing the fault that is input beforehand. FIG. 5 illustrates a state in which an explanation “paper jam” has already been input to the fault state field 166.

As illustrated in FIG. 6, at a lower part than the fault state field 166 of the input screen 152, a schematic diagram 300 which schematically illustrates the image forming apparatus 200 as the maintenance target is illustrated. The schematic diagram 300 is a diagram schematically illustrating the image forming apparatus 200. The schematic diagram 300 schematically indicates a location where a fault is occurring in the image forming apparatus 200, that is, a location which requires maintenance in the image forming apparatus 200. The schematic diagram 300, which schematically illustrates, in accordance with the product number input to the product number field 164, the model whose product number is input, is displayed on the input screen 152. The schematic diagram 300 will be described in detail later.

As illustrated in FIG. 7, at a lower part than the schematic diagram 300 of the input screen 152, a photograph attaching field 168 is illustrated. The photograph attaching field 168 is, for example, a field for attaching a photograph of a location where a fault is occurring in the image forming apparatus 200, which is captured by the imaging device 118 or the like, and for browsing a photograph that is attached beforehand. The photograph attached to the photograph attaching field 168 corresponds to maintenance content information, which is information regarding the maintenance required for the image forming apparatus 200. In the fault report system 10, attaching a photograph is not necessary and processing may proceed without attachment of a photograph to the photograph attaching field 168.

As illustrated in FIG. 8, at a lower part than the photograph attaching field 168 of the input screen 152, a cancel button 172 and a transmit button 174 are illustrated. The cancel button 172 is a button for canceling input to at least one of the serial number field 162, the product number field 164, the fault state field 166, the schematic diagram 300, and the photograph attaching field 168. The transmit button 174 is a button for transmitting, to the server apparatus 502, the information which is input to the serial number field 162, the product number field 164, the fault state field 166, the schematic diagram 300, and the photograph attaching field 168.

As described above, the display device 112 displays at least a serial number which is used as the maintenance target identification information for identifying the image forming apparatus 200 as the maintenance target, and a photograph of the image forming apparatus 200 which corresponds to the maintenance content information, which is information regarding the maintenance required for the image forming apparatus 200. On the input screen 152, the serial number, which is used as the maintenance target identification information, is displayed at an upper part than the other information including the product number, the fault state, the schematic diagram 300, and the photograph of the location where the fault is occurring. The upper part is defined as an example of the priority position.

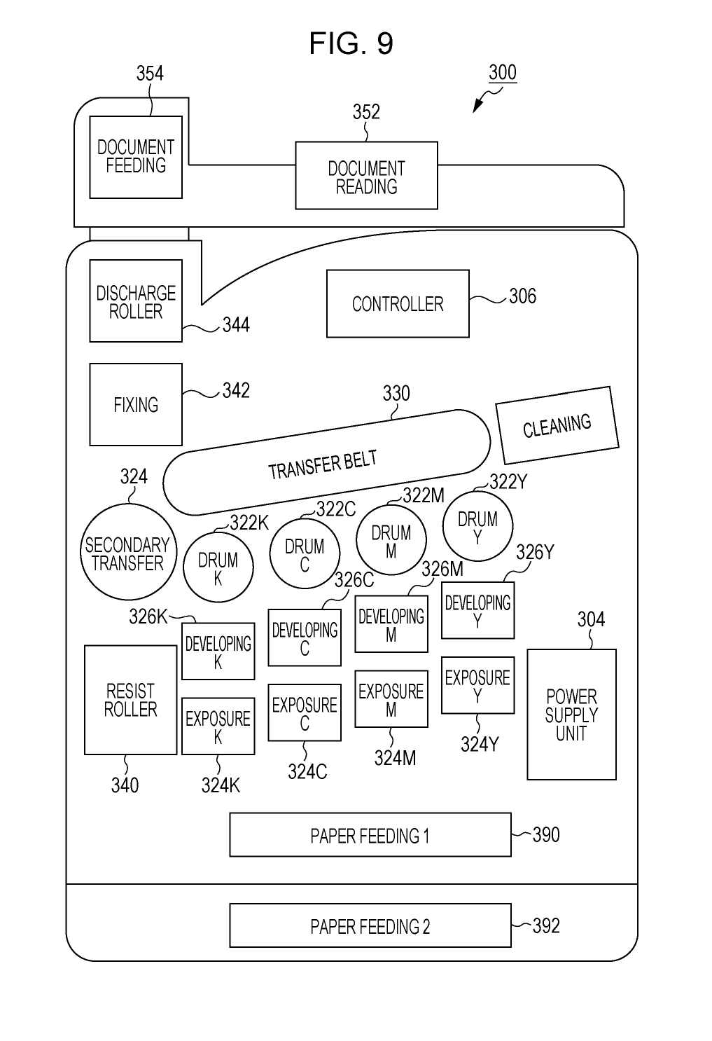

FIG. 9 is an enlarged illustration of the schematic diagram 300. As described above, the schematic diagram 300 is displayed on the input screen 152 and also on the browsing screen 154. As illustrated in FIG. 9, the schematic diagram 300 includes multiple operation units, and the multiple operation units correspond to the units of the image forming apparatus 200.

That is, an operation unit 304 corresponds to the power supply unit 204, an operation unit 306 corresponds to the controller 206, an operation unit 322Y corresponds to the photoconductor drum 222Y, an operation unit 322M corresponds to the photoconductor drum 222M, an operation unit 322C corresponds to the photoconductor drum 222C, and an operation unit 322K corresponds to the photoconductor drum 222K. Furthermore, an operation unit 326Y corresponds to the developing device 226Y, an operation unit 326M corresponds to the developing device 226M, an operation unit 326C corresponds to the developing device 226C, and an operation unit 326K corresponds to the developing device 226K.

Furthermore, an operation unit 324Y corresponds to the exposure device 224Y, an operation unit 324M corresponds to the exposure device 224M, an operation unit 324C corresponds to the exposure device 224C, and an operation unit 324K corresponds to the exposure device 224K. An operation unit 390 corresponds to the first paper feeding device 290, an operation unit 392 corresponds to the second paper feeding device 292, an operation unit 340 corresponds to the resist roller 240, an operation unit 324 corresponds to the secondary transfer device 234, an operation unit 342 corresponds to the fixing device 242, and an operation unit 344 corresponds to the discharge roller 244. An operation unit 352 corresponds to the document reading unit 252, and an operation unit 354 corresponds to the document feeding unit 254.

In the schematic diagram 300, by touching an operation unit which corresponds to a unit of the image forming apparatus 200, an operator is able to report the fault location. For example, when the operator recognizes the occurrence of the fault at the transfer belt 230, for example, by confirming an error displayed on the display device 208 or visually confirming the state of the image forming apparatus 200, the operator is able to report that the fault location at the image forming apparatus 200 is the transfer belt 230 by touching the operation unit 330.

FIGS. 10 to 13 each illustrate the terminal apparatus 100 which displays the browsing screen 154, which is a screen displayed in the report browsing mode. The browsing screen 154 is of a size that is not able to be displayed entirely on the display device 112. The entire screen may be viewed when an operator scrolls a displayed part by dragging a finger on the display device 112. FIG. 10 illustrates the first state after the screen shifts to the browsing screen 154.

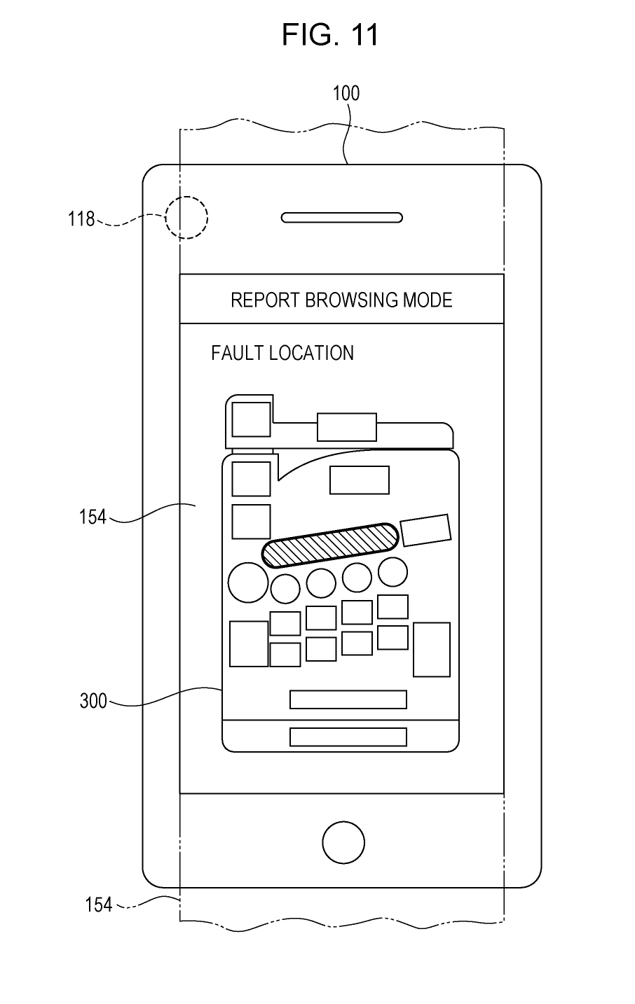

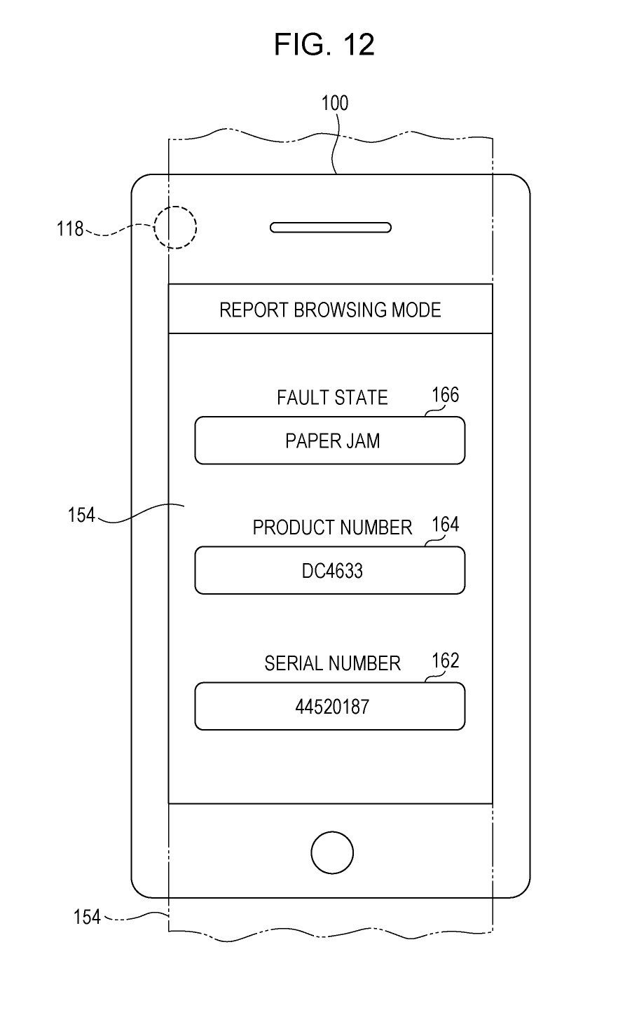

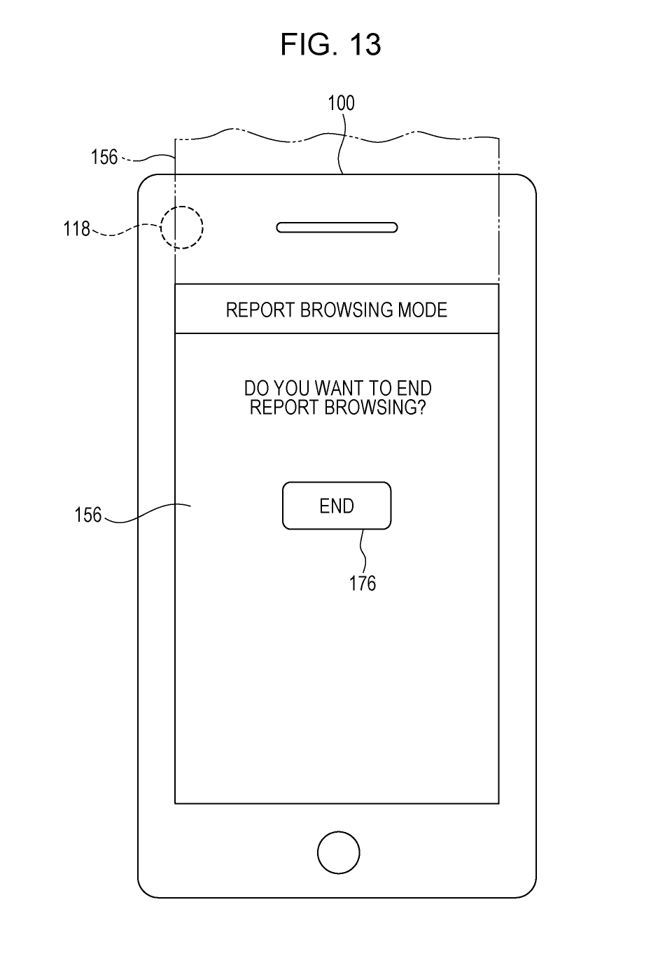

FIG. 11 illustrates the terminal apparatus 100 which displays a lower part than the part of the browsing screen 154 illustrated in FIG. 10. FIG. 12 illustrates the terminal apparatus 100 which displays a lower part than the part of the browsing screen 154 illustrated in FIG. 11. FIG. 13 illustrates the terminal apparatus 100 which displays a lower part than the part of the browsing screen 154 illustrated in FIG. 12.

On the input screen 152 described above, among the plural entries, the serial number field 162 is displayed at the uppermost part. Then, from the top to the bottom, entries are displayed in the order of the product number field 164, the fault state field 166, the schematic diagram 300, and the photograph attaching field 168. In contrast, on the browsing screen 154, as illustrated in FIGS. 10 to 13, among the plural entries, the photograph attaching field 168 is displayed at the uppermost part. Then, from the top to the bottom, entries are displayed in the order of the schematic diagram 300, the fault state field 166, the product number field 164, and the serial number field 162. Furthermore, as illustrated in FIG. 13, below the serial number field 162, an end button 176 which is a button for ending the report browsing mode is displayed.

As described above, in the fault report system 10, the display device 112 displays plural entries to be input, which are the serial number field 162, the product number field 164, the fault state field 166, the schematic diagram 300, and the photograph attaching field 168, in different positions on the display device 112 between the input screen 152 and the browsing screen 154. Furthermore, on the browsing screen 154, the display device 112 displays the photograph of the image forming apparatus 200, which is the maintenance content information, at an upper part than the other information including the serial number, the product number, the fault state, and the schematic diagram 300. The uppermost part is defined as an example of the priority position.

In the case where a photograph of the location where maintenance of the image forming apparatus 200 is required is captured by the imaging device 118 at the time of inputting, the photograph of the image forming apparatus 200, which is the maintenance content information, is displayed at an upper part than the other information on the browsing screen 154, as described above. In contrast, in the case where a photograph of the image forming apparatus 200 is not captured at the time of inputting, the schematic diagram 300 is displayed, as the maintenance content information, at an upper part than the other information on the browsing screen 154.

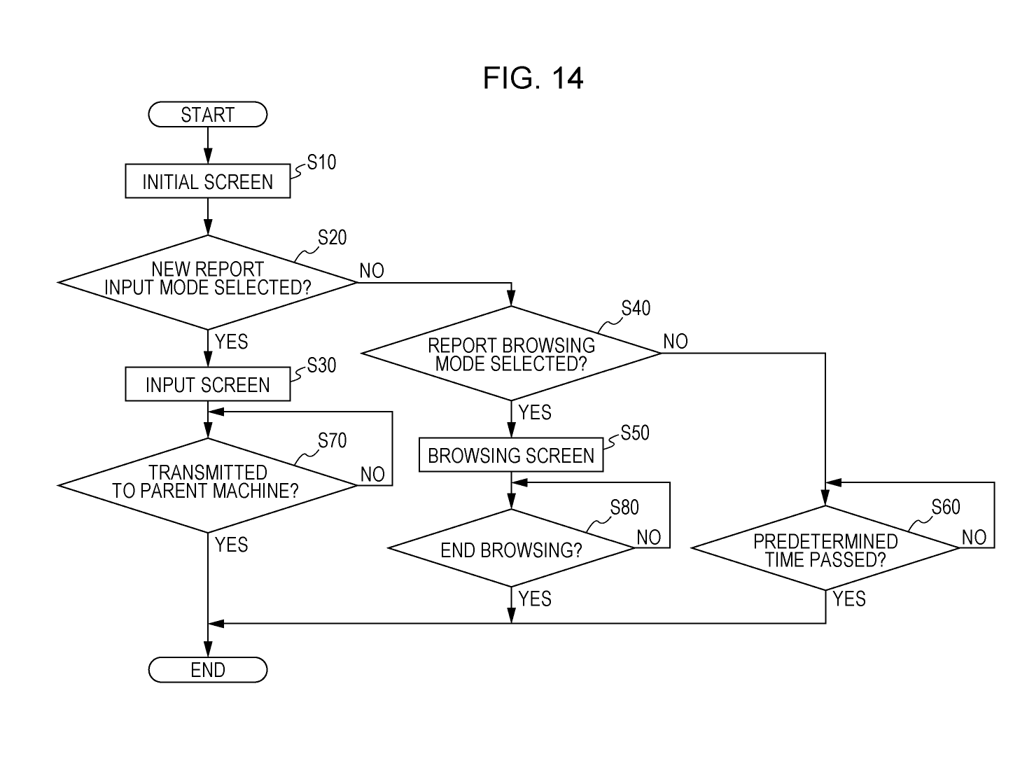

FIG. 14 is a flowchart illustrating a process performed by the fault report system 10.

As illustrated in FIG. 14, in step S10, which is the first step, the CPU 102 starts a program, and causes the display device 112 to display the initial screen 140.

When it is determined in step S20 that the new report input mode is selected, the CPU 102 shifts the screen of the display device 112 to the input screen 152 in step S30.

When it is determined in step S40 that the report browsing mode is selected, the CPU 102 shifts the screen of the display device 112 to the browsing screen 154 in step S50.

When it is determined in step S60 that a predetermined period of time has passed in a state in which neither the new report input mode nor the report browsing mode is selected, the CPU 102 ends the process.

After the transmit button 174 is operated and it is confirmed that an input entry has been transmitted to the server apparatus 502 in step S70, the CPU 102 ends the process.

After it is confirmed that the end button 176 has been operated in step S80, the CPU 102 ends the process.

In the foregoing exemplary embodiment, the example in which the uppermost part is displayed on the initial display state has been described. However, the priority position is not limited to the upper part. For example, when the leftmost part is displayed initially by horizontal scroll, the left side is defined as the priority position.

### INDUSTRIAL APPLICABILITY

As described above, the present invention is applicable to a terminal apparatus, a fault report system, and a computer readable medium for reporting a fault of an image forming apparatus such as a copy machine, a facsimile machine, and a printer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A terminal apparatus comprising:
a display that displays at least an input screen for displaying a plurality of entries to be input and a browsing screen for browsing the plurality of entries which have already been input; and
an input unit that inputs the plurality of entries,
wherein the display displays the plurality of entries at different positions on the display between the input screen and the browsing screen.

2. The terminal apparatus according to claim 1,
wherein the display displays at least, as the plurality of entries, maintenance target identification information for identifying a maintenance target and maintenance content information regarding maintenance required for the identified maintenance target, and
wherein on the input screen, the maintenance target identification information is displayed closer to a priority position than other entries among the plurality of entries, and on the browsing screen, the maintenance content information is displayed closer to a priority position than other entries among the plurality of entries.

3. The terminal apparatus according to claim 2, wherein a captured photograph is used as the maintenance content information, and the captured photograph is displayed, on the browsing screen, closer to the priority position than the other entries among the plurality of entries.

4. The terminal apparatus according to claim 2, wherein the display displays a schematic diagram that schematically illustrates a maintenance required location.

5. The terminal apparatus according to claim 3, wherein the display displays a schematic diagram that schematically illustrates a maintenance required location.

6. The terminal apparatus according to claim 4, wherein, when a photograph is not captured by an imaging device, the display displays the schematic diagram, as the maintenance content information, on the browsing screen at a position closer to the priority position than the other entries among the plurality of entries.

7. The terminal apparatus according to claim 5, wherein, when a photograph is not captured by an imaging device, the display displays the schematic diagram, as the maintenance content information, on the browsing screen at a position closer to the priority position than the other entries among the plurality of entries.

8. The terminal apparatus according to claim 1,
wherein the terminal apparatus communicates with a parent apparatus which includes a memory, and
wherein the plurality of entries input using the input unit are stored in the memory, and the terminal apparatus displays, on the display, the plurality of entries stored in the memory.

9. The terminal apparatus according to claim 2,
wherein the terminal apparatus communicates with a parent apparatus which includes a memory, and
wherein the plurality of entries input using the input unit are stored in the memory, and the terminal apparatus displays, on the display, the plurality of entries stored in the memory.

10. The terminal apparatus according to claim 3,
wherein the terminal apparatus communicates with a parent apparatus which includes a memory, and
wherein the plurality of entries input using the input unit are stored in the memory, and the terminal apparatus displays, on the display, the plurality of entries stored in the memory.

11. The terminal apparatus according to claim 4,
wherein the terminal apparatus communicates with a parent apparatus which includes a memory, and
wherein the plurality of entries input using the input unit are stored in the memory, and the terminal apparatus displays, on the display, the plurality of entries stored in the memory.

12. The terminal apparatus according to claim 5,
wherein the terminal apparatus communicates with a parent apparatus which includes a memory, and
wherein the plurality of entries input using the input unit are stored in the memory, and the terminal apparatus displays, on the display, the plurality of entries stored in the memory.

13. The terminal apparatus according to claim 6,
wherein the terminal apparatus communicates with a parent apparatus which includes a memory, and
wherein the plurality of entries input using the input unit are stored in the memory, and the terminal apparatus displays, on the display, the plurality of entries stored in the memory.

14. The terminal apparatus according to claim 7,
wherein the terminal apparatus communicates with a parent apparatus which includes a memory, and
wherein the plurality of entries input using the input unit are stored in the memory, and the terminal apparatus displays, on the display, the plurality of entries stored in the memory.

15. A fault report system comprising:
a terminal apparatus; and
a parent apparatus that communicates with the terminal apparatus,
wherein the terminal apparatus includes a display that displays at least an input screen for displaying a plurality of entries to be input and a browsing screen for browsing the plurality of entries which have already been input, and an input unit that inputs the plurality of entries, and the display displays the plurality of entries at different positions on the display between the input screen and the browsing screen, and
wherein the parent apparatus includes a memory that stores the plurality of entries which are input by the input unit.

16. A non-transitory computer readable medium storing a program causing a computer to execute a process comprising:
displaying at least an input screen for displaying a plurality of entries to be input and a browsing screen for browsing the plurality of entries which have already been input; and
inputting the plurality of entries,
wherein the plurality of entries are displayed at different positions between the input screen and the browsing screen.
